(19) United States
(12) Patent Application Publication
(10) Pub. No.: US 2011/0075172 A1
(43) Pub. Date: Mar. 31, 2011

(54) PRINT INFORMATION ACQUIRING METHOD, PRINT INFORMATION ACQUIRING APPARATUS, PROFILE GENERATING METHOD, AND COMPUTER-READABLE RECORDING MEDIUM WITH PROGRAM RECORDED THEREIN

(75) Inventor: Takeshi KATAYAMA, Minato-ku (JP)

(73) Assignee: FUJIFILM Corporation, Tokyo (JP)

(21) Appl. No.: 12/893,823

(22) Filed: Sep. 29, 2010

(30) Foreign Application Priority Data
Sep. 30, 2009 (JP) 2009-228984
Feb. 25, 2010 (JP) 2010-041078
Feb. 25, 2010 (JP) 2010-041080

(51) Int. Cl. H04N 1/60

(52) U.S. Cl. 358/1.9

(57) ABSTRACT

An association table is generated which associates print information with color values. Print information of a print is encoded into target color values based on the generated association table. Image data of management patches having the target color values are added to image data for printing the print. The print, which is printed by a printing machine, is colorimetrically measured to acquire color values of the management patches. The acquired color values of the management patches are decoded into print information based on the association table. The association table is generated depending on a gamut of the printing machine.

### CROSS-REFERENCE TO RELATED APPLICATION

This application is based upon and claims the benefit of priority from Japanese Patent Applications No. 2009-228984 filed on Sep. 30, 2009, No. 2010-041078 filed on Feb. 25, 2010 and No. 2010-041080 filed on Feb. 25, 2010, of which the contents are incorporated herein by reference.

### BACKGROUND OF THE INVENTION

1. Field of the Invention

The present invention relates to a print information acquiring method, a print information acquiring apparatus, a profile generating method, and a computer-readable recording medium with a program recorded therein for measuring color values of management patches added to a print and acquiring print information of the print based on the measured color values.

2. Description of the Related Art

With significant advances in inkjet technology in recent years, it is becoming possible for inkjet printers to produce large color prints of high quality at high speeds. Inkjet printers are not only popular for private or home use, but also are widely used in commercial applications nowadays. Inkjet printers make it possible to print on POP (Point Of Purchase) posters, wall posters, large-size mediums such as outdoor advertisements and billboards, roll mediums, and thick hard mediums.

There are a wide variety of print mediums (hereinafter also referred to as “mediums”) available for use in prints to meet various commercial demands. For example, such print mediums include paper mediums such as synthetic paper, thick paper, aluminum-evaporated paper, etc., resin mediums such as vinyl chloride, PET, etc., and tarpaulin paper made of woven fiber cloth with synthetic resin films applied to both surfaces thereof.

Since advertisement prints are expected to be effective to arouse consumer's motivation to buy advertised products through the consumer's visual sensation, the color finish of prints is of particular importance. Heretofore, there have been disclosed various color matching technologies such as a method of generating an ICC (International Color Consortium) profile, a method of adjusting a designated color, etc., as print color managing means. According to such disclosed color matching technologies, it is the general practice to print a color chart including a plurality of color patches of different colors with a printing machine, and to feed back evaluation results of the color chart to the printing machine.

For example, a color chart printed by a printing machine and having color patches of 100 through 1000 colors is measured by a colorimeter, and an ICC profile of the printing machine can be generated based on the measured color values. Furthermore, an operator can visually recognize a color chart, the colors of which are gradually changed in the vicinity of a designated color, can select the color of a color patch judged as being closest to the designated color, and can make fine adjustments to match the selected color.

For accurately reproducing colors on the printing machine and making fine color adjustments, it is desirable for print information of a color chart, which has actually been measured or evaluated, to be capable of being tracked down. The print information refers to various items of information about printing, and signifies a broad concept covering not only printing conditions including a printing mode, a print medium type, etc., but also an intended application, a printing machine identification number, a designated color number, etc.

There has been proposed, as one process of checking preset print information against a printed color chart and managing the print information without fail, a process of embedding each item of print information based on the colors of color patches and their layout. The proposed process allows a colorimeter to be used in place of a readout means for reading an identification code such as a bar code or the like, and further makes it possible to identify print information correctly with a few color patches.

Japanese Laid-Open Patent Publication No. 2005-328255 discloses a color chart wherein a certain color is selected from color proof color patches and the position of the color patch of the certain color is changed depending on preset printing conditions. The publication also discloses a system for and a method of identifying printing conditions for the color chart by measuring the color chart with a colorimeter and acquiring positional information (an address) of the color patch of the certain color on the color chart.

Japanese Laid-Open Patent Publication No. 2007-221571 discloses a color chart having management patches (corresponding to “attribute specifying color patches” in Claim 1 of Japanese Laid-Open Patent Publication No. 2007-221571) in addition to color proof patches. This publication also discloses a system and method of identifying printing conditions for the color chart by measuring the color chart with a colorimeter, selecting one of the color proof patches that has the same color as the management color patch, and acquiring positional information (an address) of the selected color proof color patch on the color chart.

The methods revealed in Japanese Laid-Open Patent Publication No. 2005-328255 and Japanese Laid-Open Patent Publication No. 2007-221571 share a technical concept by which two-dimensional positional information on a color chart is referred to and converted into print information.

However, since the positional information on the color chart is directly related to elements of the print information, even when a color chart is printed by the same printing machine, management patches on the color chart cannot be used as a means for acquiring print information.

For example, the process disclosed in Japanese Laid-Open Patent Publication No. 2005-328255 cannot be applied to a color chart including only designated colors or colors in the neighborhood of such designated colors (hereinafter referred to as a “designated color adjusting color chart”), because color intervals of the color patches are so small that it is difficult to detect colors appropriately, and thus, erroneous identification of print information may occur.

According to the process disclosed in Japanese Laid-Open Patent Publication No. 2007-221571, the definition of positions (addresses) of the color patches has to be changed each time details plotted (recorded) on the color chart, particularly the number and array of color patches, are changed.

Details plotted on prints other than color charts do not include color patches that refer to positional information within print areas thereof. Therefore, management patches cannot be used on these types of prints either.

### SUMMARY OF THE INVENTION

It is an object of the present invention to provide a print information acquiring method, a print information acquiring apparatus, a profile generating method, and a computer-readable recording medium with a program recorded therein, for acquiring print information of prints without losing consistency in a printing machine when different types of color charts and prints other than color charts are printed by the printing machine.

According to the present invention, there is provided a print information acquiring method comprising the steps of generating an association table associating print information with color values, encoding print information of a print into prescribed color values based on the generated association table, adding image data of management patches having the prescribed color values to image data for printing the print, acquiring color values of the management patches added to the print that is printed by a printing machine, and decoding the acquired color values of the management patches into the print information based on the association table, wherein in the step of generating the association table, the association table is generated depending on a gamut of the printing machine.

According to the present invention, there also is provided a print information acquiring apparatus comprising an association table generator for generating an association table associating print information with color values, an encoding processor for encoding print information of a print into prescribed color values based on the association table generated by the association table generator, a patch adder for adding image data of management patches having the prescribed color values to image data for printing the print, a colorimetric unit for acquiring color values of the management patches added by the patch adder to the print that is printed by a printing machine, and a decoding processor for decoding the color values of the management patches acquired by the colorimetric unit into the print information based on the association table, wherein the association table is generated depending on a gamut of the printing machine.

According to the present invention, there is provided a profile generating method comprising the steps of generating an association table associating print information with color values, encoding print information of a color chart having a plurality of color patches into prescribed color values based on the generated association table, adding image data of management patches having the prescribed color values to image data for printing the color chart, acquiring color values of the color patches and color values of the management patches added to the color chart that is printed by a printing machine, decoding the acquired color values of the management patches into the print information based on the association table, and generating a profile based on the acquired color values of the color patches and the decoded print information.

According to the present invention, there is provided a computer-readable recording medium storing therein a program for enabling a computer to perform the functions of generating an association table associating print information with color values, depending on a gamut of a printing machine for printing a print, encoding print information of the print into prescribed color values based on the generated association table, adding image data of management patches having the prescribed color values to image data for printing the print, acquiring color values of the management patches added to the print that is printed by the printing machine, and decoding the color values of the acquired management patches into the print information based on the association table.

With the print information acquiring method, the print information acquiring apparatus, the profile generating method, and the computer-readable recording medium with a program recorded therein according to the present invention, an association table is generated that associates print information with color values, print information of a print is encoded into prescribed color values based on the generated association table, image data of management patches having the prescribed color values are added to image data for printing the print, color values of the management patches added to the print that is printed by a printing machine are acquired, and the acquired color values of the management patches are decoded into the print information based on the association table, wherein the association table is generated depending on a gamut of the printing machine. The print information thus can be acquired independently of plotted (recorded) contents of the print. Color values in a range where colors can be reproduced by the printing machine and the print information can appropriately be associated with each other. Even when different types of color charts and prints other than color charts are printed, print information of the prints can be acquired without loss of consistency within the same printing machine.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a printing system according to an embodiment of the present invention;

FIG. 2 is a front elevational view of a profile color chart according to the embodiment;

FIG. 3 is a front elevational view of a designated color adjusting color chart according to the embodiment;

FIG. 4 is a functional block diagram of an image processing apparatus according to the embodiment;

FIG. 5 is a flowchart of a sequence for producing a print having appropriate colors with the printing system according to the embodiment;

FIG. 6 is a flowchart of a sequence for adding management patches with encoded print information to a print;

FIG. 7 is a diagram showing by way of example a color association table generated by an association table generator according to the embodiment;

FIG. 8 is a flowchart of a sequence for acquiring print information from management patches added to a print;

FIG. 9 is a graph illustrating time-dependent changes in color differences on a print, which are caused by dry-down;

FIG. 10A is a functional block diagram showing processing details of a time manager upon notification of a color chart printing request;

FIG. 10B is a functional block diagram showing processing details of the time manager upon notification of completion of colorimetric measurement;

FIG. 11 is a graph showing a positional relationship between the gamuts of two printing machines;

FIG. 12 is a diagram illustrating a process of setting ID numbers for three printing machines;

FIGS. 13A and 13B are conceptual diagrams showing examples of determining ink amounts used to print management patches; and

FIG. 14 is a front elevational view of a profile color chart according to a modification of the embodiment.

### DESCRIPTION OF THE PREFERRED EMBODIMENTS

A print information acquiring method according to a preferred embodiment of the present invention, in relation to a print information acquiring apparatus and a printing system for carrying out the print information acquiring method, will be described in detail below with reference to the accompanying drawings.

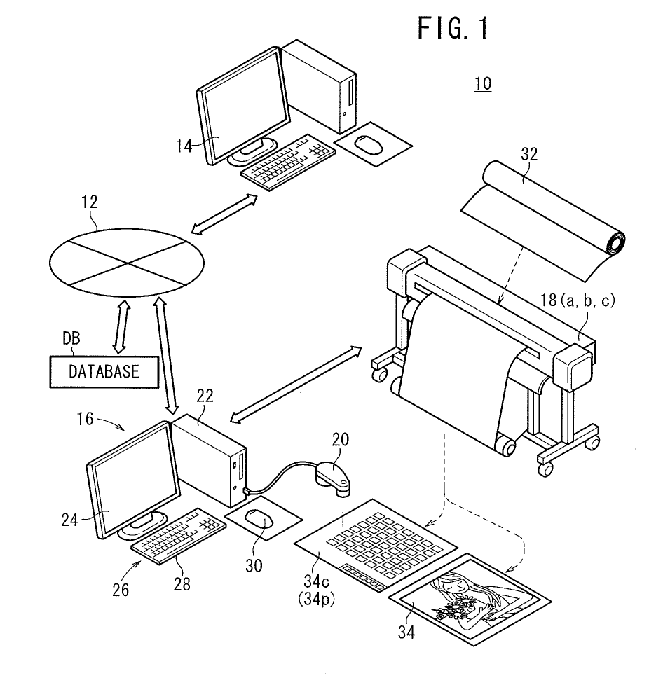

FIG. 1 shows in perspective a printing system 10 incorporating an image processing apparatus 16 as a print information acquiring apparatus according to an embodiment of the present invention.

As shown in FIG. 1, the printing system 10 basically comprises a LAN 12, an editing apparatus 14, an image processing apparatus 16, a printing machine 18, and a colorimeter (colorimetric unit) 20.

The LAN 12 is a network constructed according to communication standards such as Ethernet (registered trademark) or the like. The editing apparatus 14 and the image processing apparatus 16 are connected to each other as well as to a database DB by a wired or wireless link through the LAN 12.

The editing apparatus 14 is capable of editing an arrangement of color images made up of characters, figures, pictures, photos, etc., on each of pages to be printed. The editing apparatus 14 generates electronic manuscripts in a page description language (hereinafter referred to as “PDL”), e.g., 8-bit image data in color channels made up of four colors (C, M, Y, K) or three colors (R, G, B).

PDL refers to a language that is descriptive of image information, including format information, positional information, color information (including density information), etc., of characters, figures, etc., in a “page” that serves as an output unit for printing, displaying, or the like. Known types of PDL include PDF (Portable Document Format according to ISO32000-1:2008), PostScript (registered trademark) of AdobeSystems, and XPS (XML Paper Specification).

A color scanner, not shown, is connected to the editing apparatus 14. The color scanner is capable of optically reading a color original set in position. Therefore, the editing apparatus 14 can acquire color image data from the color scanner, based on the color original read thereby, as image data of an electronic manuscript.

The image processing apparatus 16 converts color image data of an electronic manuscript described by PDL and acquired from the editing apparatus 14 into bitmap image data (a type of raster image data), performs desired image processing, e.g., a color conversion process, an image scaling process, an image arranging process, etc., on the bitmap image data, converts the processed bitmap image data into print signals that match the printing process of the printing machine 18, and sends the print signals to the printing machine 18.

The image processing apparatus 16 comprises a main unit 22 including a CPU, a memory, etc., a display device 24 for displaying color images, and an input device 26 serving as an input unit including a keyboard 28 and a mouse 30. The colorimeter 20 is connected to the main unit 22 of the image processing apparatus 16.

The printing machine 18 comprises an inkjet printing apparatus for producing a color image based on a combination of standard inks of colors C, M, Y, K (process colors) and optional inks of light colors such as LC, LM, etc., and W (white). The printing machine 18 controls propulsion of inks onto a print medium 32 (rolled non-printed medium in FIG. 1) based on print signals received from an external apparatus, e.g., the image processing apparatus 16, in order to print a color image on the print medium 32, thereby producing a print 34, which may include a profile color chart 34p and a designated color adjusting color chart 34c.

The print medium 32 may comprise a paper medium such as synthetic paper, thick paper, aluminum-evaporated paper, or the like, a resin medium such as vinyl chloride, PET, or the like, or tarpaulin paper, or the like.

The colorimeter 20 measures color values of an object to be measured. Such color values refer not only to tristimulus values X, Y, Z, the coordinates L*, a*, b of a uniform color space, etc., but also to a distribution of optical physical values (hereinafter referred to as “spectral data”) with respect to wavelengths, e.g., a spectral radiance distribution, a spectral sensitivity distribution, a spectral reflectivity, or a spectral transmittance.

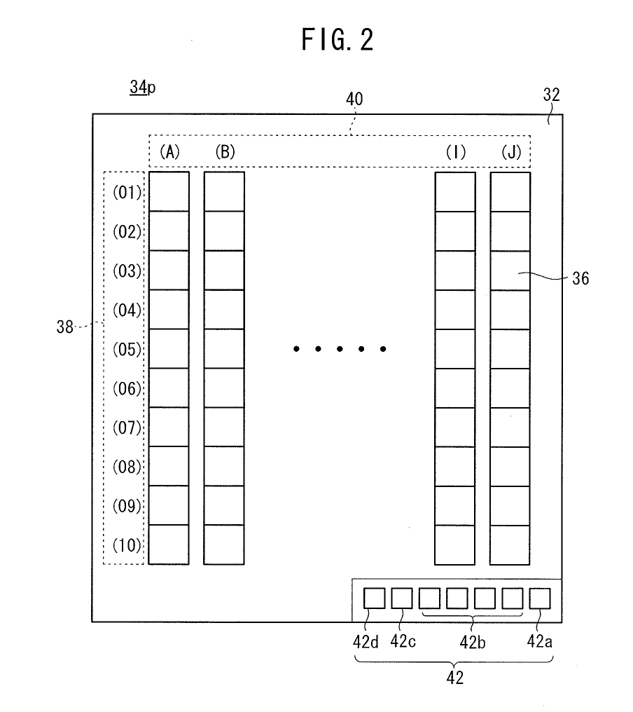

FIG. 2 is a front elevational view of a profile color chart 34p according to the first embodiment.

The profile color chart 34p shown in FIG. 2 comprises 100 color patches 36 of different colors, which are substantially identical in shape and arranged in rows and columns, a sequence of numbers 38 and a sequence of alphabetical letters 40 for identifying positions of the color patches 36 along directions of the rows and columns, and management patches 42 for identifying printing conditions for printing the profile color chart 34p, all of which are printed on the print medium 32.

The color patches 36 are arranged in a matrix having 10 vertical columns and 10 horizontal rows. The color patches 36 in each of the vertical columns are held together closely with no spaces therebetween, whereas the color patches 36 in each of the horizontal rows are spaced by given intervals. Colors of the respective color patches 36 are set to given values within a range of signal levels made up of C, M, Y, K values (a percentage range from 0% to 100%, or an 8-bit gradation range from 0 to 255).

The sequence of numbers 38 represents a vertical string of characters ranging from (01) to (10) positioned to the left of the respective rows of color patches 36 in alignment with the rows. The sequence of alphabetical letters 40 represents a horizontal string of characters ranging from (A) to (J) positioned at the top of the respective columns of color patches 36 in alignment with the columns.

The management patches 42 include, successively from the left, one head patch 42a, four print information patches 42b, one checksum patch (colorimetry success/failure detecting patch) 42c, and one tail patch 42d.

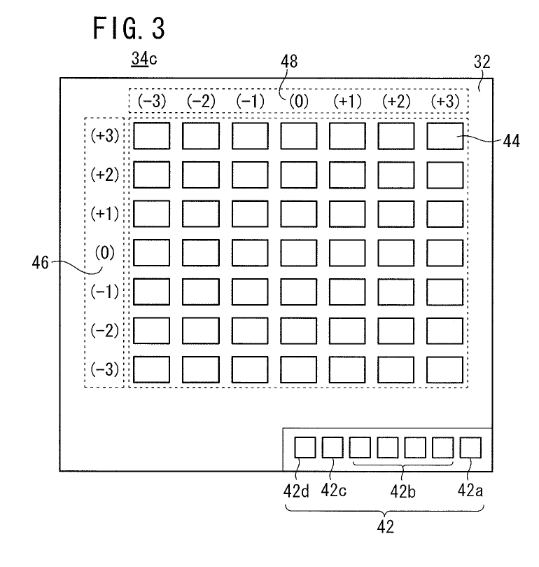

FIG. 3 is a front elevational view of a designated color adjusting color chart 34c according to the present embodiment.

The designated color adjusting color chart 34c shown in FIG. 3 comprises 49 color patches 44 of different colors that are substantially identical in shape, row numbers 46 and column numbers 48 for identifying positions of the color patches 4 along directions of the rows and columns, and management patches 42 for identifying printing conditions for printing the designated color adjusting color chart 34c, all of which are printed on the print medium 32.

The color patches 44 are arranged in a matrix having 7 vertical columns and 7 horizontal rows, which are spaced from each other by given intervals. Colors of the respective color patches 44 are set to given values in a range of signal levels made up of C, M, Y, K values (a percentage range from 0% to 100%, or an 8-bit gradation range from 0 to 255).

The row numbers 46, which serve as identification information, represent a vertical string of characters ranging from (+3) to (−3) positioned to the left of the respective rows of color patches 44 in alignment therewith. The column numbers 48, which also serve as identification information, represent a horizontal string of characters ranging from (−3) to (+3) positioned at the top of the respective columns of color patches 44 in alignment therewith.

The management patches 42 are identical to the management patches 42 shown in FIG. 2 and will not be described in detail.

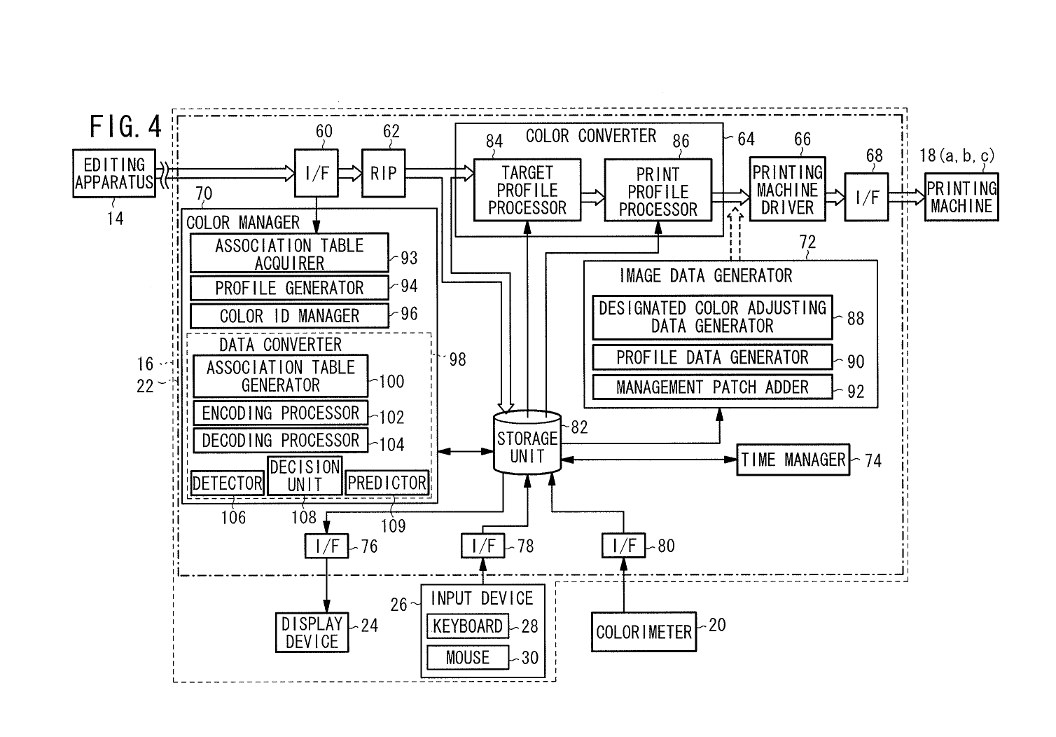

FIG. 4 shows in block form the image processing apparatus 16 according to the present embodiment. In FIG. 4, an electronic manuscript is supplied along directions indicated by the outlined solid-line arrows. Color-chart image data is supplied along directions indicated by the outlined broken-line arrows. Various other data are supplied along directions indicated by the solid-line arrows.

As shown in FIG. 4, the main unit 22 of the image processing apparatus 16 includes an I/F 60 for entering an electronic manuscript supplied from the editing apparatus 14, an RIP (Raster Imaging Processor) 62 for converting the PDL format of the electronic manuscript supplied from the I/F 60 into a raster format, a color converter 64 for performing a color converting process on the converted C, M, Y, K values (or R, G, B values) of the electronic manuscript from the RIP 62 in order to produce image data having new C, M, Y, K values, a printing machine driver 66 for converting the image data, which is made up of new C, M, Y, K values produced by the color converter 64, into print control signals (ink propulsion control data) that match the printing machine 18, and an I/F 68 for outputting the print control signals generated by the printing machine driver 66 to the printing machine 18.

The main unit 22 also includes a color manager 70 for managing profiles of different printing machines 18, an image data generator 72 for generating image data to print the designated color adjusting color chart 34c or the profile color chart 34p, a time manager 74 for managing various times such as a printing request time, a colorimetry completion time, etc., an I/F 76 for connection to the display device 24, an I/F 78 for connection to the input device 26 including the keyboard 28 and the mouse 30, and an I/F 80 for connection to the colorimeter 20.

The main unit 22 also includes a storage unit 82 for storing various data supplied from various components of the main unit 22, and for supplying stored data to various components of the main unit 22. The storage unit 82 is connected respectively to the RIP 62, the color converter 64, the color manager 70, the image data generator 72, the time manager 74, the I/F 76, the I/F 78, and the I/F 80.

The color converter 64 comprises a target profile processor 84 for converting device-dependent data into device-independent data, and a print profile processor 86 for converting device-independent data into device-dependent data. Device-dependent data refer to data defined in terms of C, M, Y, K values, R, G, B values, or the like, for appropriately driving various devices. Device-independent data refer to data defined in terms of a display system such as an HSL system, an HSB system, a CIELAB coordinate system, a CIELUV coordinate system, an XYZ system, or the like.

The image data generator 72 comprises a designated color adjusting data generator 88 for generating image data to print the designated color adjusting color chart 34c, a profile data generator 90 for generating image data to print the profile color chart 34p, and a management patch adder (patch adder) 92 for adding management patches 42 to a given position in addition to the image data.

The color manager 70 comprises an association table acquirer 93 for acquiring a color association table (association table), to be described later, from an external device through the I/F 60, a profile generator 94 for generating profiles for respective printing machines 18, a color ID manager 96 for managing color IDs for the management patches 42, and a data converter 98 for converting various data, such as data of printing conditions, according to prescribed rules. The data converter 98 comprises an association table generator 100 for generating a color association table, which associates color values, e.g., L*, a*, values, with print information, an encoding processor (printing time acquirer) 102 for encoding print information into color values, a decoding processor 104 for decoding color values into print information, a detector 106 for detecting a head patch 42a or a tail patch 42d of the management patches 42, a decision unit 108 for determining whether or not the colorimeter 20 has successfully acquired color values, and a predictor 109 for predicting color values of the management patches 42 in a steady state of dry-down.

The RIP 62 can perform various image processing functions, including an image scaling process depending on the resolution, etc., of the printing machine 18, and a rotating and inverting process depending on a printing format used when an electronic manuscript is converted into raster image data.

From the C, M, Y, K values, the printing machine driver 66 generates ink propulsion control data corresponding to ink colors (C, M, Y, K, LC, LM, or W). Such ink propulsion control data control the printing machine 18 so as to eject inks appropriately (ink ejection ON/OFF, ink dot diameters, etc.). The printing machine driver 66 may generate ink propulsion control data according to a known algorithm, such as a dither matrix method, an error diffusion method, or the like, although conversion thereof is required from an 8-bit multiple-gradation image into a low-gradation image such as a binary image.

The target profile processor 84 or the print profile processor 86 is capable of correcting a profile depending on a print mode of the printing machine 18. The print mode refers to various print settings, such as the number of nozzles of the print head, the timing (unidirectional/bidirectional) of ink ejection as the print head scans, the number of passes, the number and types of inks used in the printing machine 18, an algorithm for generating ink propulsion control data, etc.

The main unit 22 has a controller (not shown) comprising a CPU, etc., for controlling all of the image processing functions described above. Specifically, the controller controls not only operations of various components of the main unit 22, e.g., reading data from and writing data to the storage unit 82, but also transmission of display signals via the I/F 76 to the display device 24, and acquisition of colorimetric data from the colorimeter 20 via the I/F 80.

The image processing apparatus 16 according to the present embodiment is constructed as described above. The image processing functions described above can be performed according to application programs stored in the storage unit 82, which operate under the control of a basic program (operating system).

Such programs may be recorded in a computer-readable recording medium, and may be read into a computer system and executed thereby. The term “computer system” includes an operating system (OS) and hardware including peripheral devices. The computer-readable recording medium comprises a portable medium such as a flexible disk, a magnetooptical disk, a CD-ROM, or the like, or a storage unit such as a hard disk or the like incorporated in the computer system. The computer-readable recording medium may also include a medium for dynamically holding programs for a short period of time, such as a communications line for transmitting programs via a network such as the Internet or the like, a communication channel such as a telephone line, or a memory for holding programs for a certain period of time such as a volatile memory in a computer system, which operates as a server or client in a network environment.

The printing system 10 according to the present embodiment is basically constructed as described above. Operations of the printing system 10 will be described below.

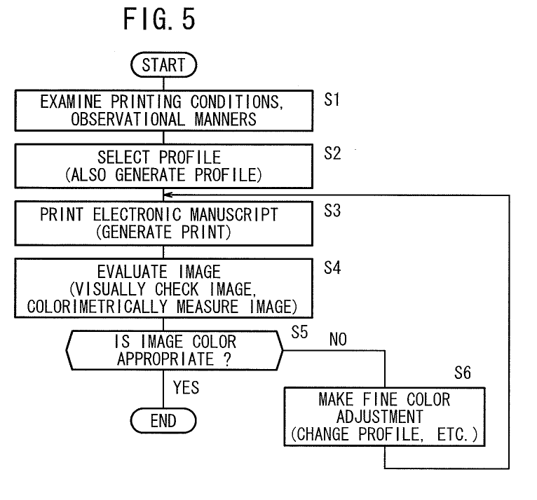

FIG. 5 is a flowchart of a sequence for producing a print 34 having appropriate colors using the printing system 10. A process of producing a print 34 will be described below, mainly with reference to FIGS. 1 and 5.

The operator examines printing conditions and observational manners of a print 34 to be produced (step S1). Printing conditions refer to the type of printing machine 18 used to produce the print 34, the type of the print medium 32, or a printing mode as referred to above. Observational manners refer not only to attributes (type and spectral data) of an observational light source for the print 34, but also refer to the image type of the print 34 to be observed. The image type may represent a reflective image, i.e., an image observed with a reflective light source used as a main light source, a transmissive image, i.e., an image observed with a transmissive light source used as a main light source, or a combined image, i.e., an image observed with a reflective light source and a transmissive light source used together as main light sources.

Then, the operator selects a profile suitable for the printing machine 18 (step S2). Normally, a target profile or a print profile is stored in the storage unit 82. If a profile suitable for the printing machine 18 is not registered, i.e., is not stored in the storage unit 82, then a print profile can be generated separately.

Then, an electronic manuscript is printed using the printing machine 18, thereby producing a color print 34 (step S3). The print 34 may be laminated by a laminating apparatus, not shown, in order to provide a protective film over the image surface of the print 34. The color image of the print 34 can thus be protected to provide better abrasion resistance and toughness.

Then, the operator evaluates the color of the color image of the print 34 (step S4), and determines whether or not the color of the image is appropriate (step S5). The operator may evaluate the color of the image in order to determine whether desired hues are obtained either by visually checking the image based on observation of an overall or partial appearance of the image, or by obtaining color values of a certain area of the print 34 with the colorimeter 20, and determining whether the obtained color values fall within a desired range.

If, as a result of such image evaluation, the operator judges that the image of the print 34 is not suitable, then the operator changes the profile so as to make fine adjustments to the color of the image (step S6). Specifically, the operator may reset the profile or regenerate a new profile, or make fine adjustments to the profile, i.e., the operator may correct the presently set profile, or may correct the print data of the electronic manuscript.

Thereafter, an electronic manuscript is printed and the color of the printed image is evaluated repeatedly (steps S3 through S6) until a print 34 having a desired color is obtained.

An image processing sequence of the image processing apparatus 16 for printing an electronic manuscript (step S3) will be described in detail below with reference to FIG. 4.

When an electronic manuscript in PDL format supplied from the editing apparatus 14 is input to the image processing apparatus 16 via the LAN 12 and the I/F 60, the electronic manuscript is converted into 8-bit C, M, Y, K raster data (device-dependent image data) by the RIP 62. The 8-bit C, M, Y, K raster data then are converted into L*, a*, b* data (device-independent image data) by the target profile processor 84. The L*, a*, b* data then are converted into C, M, Y, K value data (device-dependent image data) by the print profile processor 86. The C, M, Y, K value data then are converted into print control signals (ink propulsion control data) by the printing machine driver 66. The print control signals are supplied from the printing machine driver 66 via the I/F 68 to the printing machine 18. If necessary, C, M, Y, K raster data produced by the RIP 62 are temporarily stored in the storage unit 82. Thereafter, the printing machine 18 produces a desired print 34 based on the print control signals.

Since target profiles and print profiles corresponding to a plurality of set conditions have been stored in the storage unit 82, a target profile is supplied selectively to the target profile processor 84, and a print profile is supplied selectively to the print profile processor 86, depending on various preset conditions. If profiles are corrected appropriately in view of the print mode of the printing machine 18, then more appropriate color conversion processes can be performed.

An image processing sequence of the image processing apparatus 16 for generating a profile (step S2) will be described in detail below with reference to FIG. 4.

Image data generated by the profile data generator 90 based on given C, M, Y, K value data stored in the storage unit 82 are supplied from the image data generator 72 via a path represented by the outlined broken-line arrow to the printing machine driver 66. The image data are supplied from the printing machine driver 66 to the printing machine 18, in the same manner as when an electronic manuscript is printed. The color patches 36 (see FIG. 2) of the profile color chart 34p thus produced are measured by the colorimeter 20, thereby producing color values L*, a*, b*. The color value data thus produced are temporarily stored in the storage unit 82. Thereafter, based on an associative relationship between the designated C, M, Y, K value data and the produced color values L*, a*, b*, a print profile is generated, which includes data representing a three-dimensional to four-dimensional conversion LUT.

The process of producing a print 34 of appropriate colors using the printing system 10, i.e., a direct color managing process, has been described above. An indirect color managing process based on management of print information, or more specifically, a process of adding print information of the printing machine 18 to the print 34 (or acquiring print information of the printing machine 18 from the print 34) using the management patches 42, will be described in detail below.

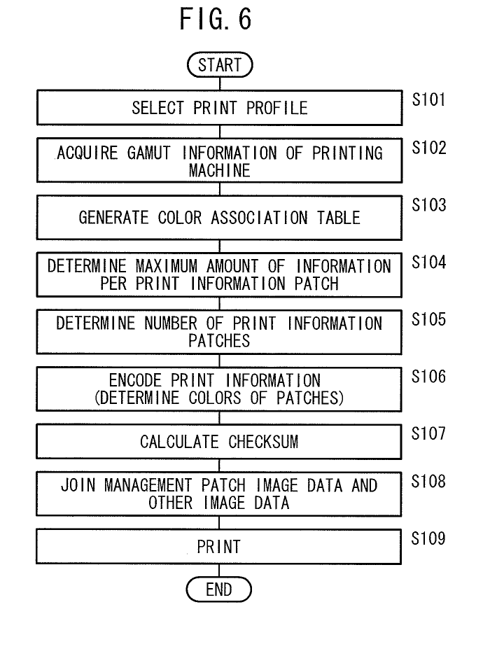

FIG. 6 is a flowchart of a sequence for adding management patches 42 with encoded print information therein to the print 34. According to this sequence, management patches 42 are added to the profile color chart 34p shown in FIG. 2, for example.

A print profile suitable for the printing machine 18 is selected (step S101). Specifically, print profiles are stored in advance in the storage unit 82 shown in FIG. 4. One of the print profiles stored in the storage unit 82, which is identical to a profile supplied to the print profile processor 86, is selected automatically or manually.

Then, gamut information of the printing machine 18 is acquired (step S102). More specifically, the gamut information of the printing machine 18 is acquired based on the print profile selected in step S101. Gamut information refers to information representing the configuration of a gamut region in a uniform color space, e.g., an L*a*b* space. The configuration of the gamut region represents the volume, shape, positional relationship, etc., of the gamut region.

Then, a color association table is generated based on the acquired gamut information of the printing machine 18 (step S103). More specifically, a color association table is generated by the association table generator 100, and then, if necessary, the color association table is stored in the storage unit 82 (see FIG. 4). Alternatively, color association tables may be stored in the database DB (see FIG. 1), and a desired one of the stored color association tables may be acquired from the database DB. In this case, depending on a request from the main unit 22, a color association table suitable for the printing machine 18 and/or the print medium 32 is selected from the database DB. The selected color association table is supplied through the LAN 12 and the I/F 60, and is acquired by the association table acquirer 93.

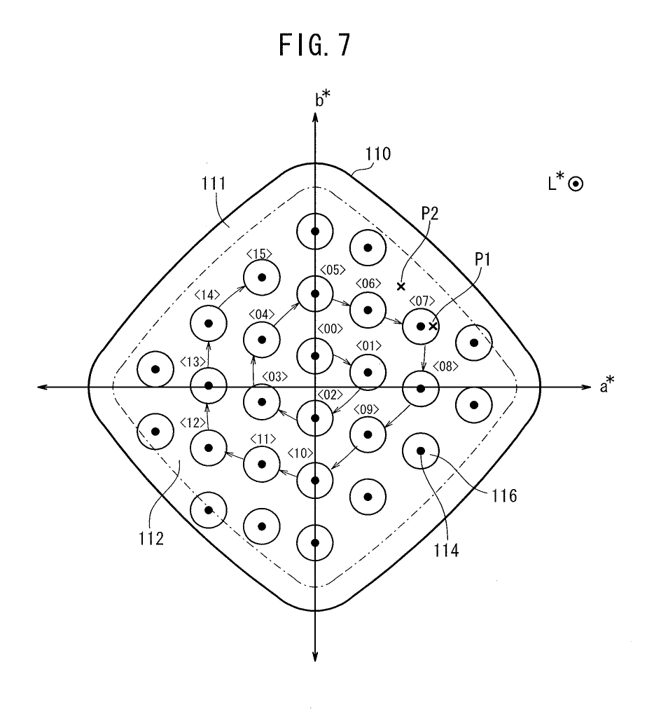

FIG. 7 is a diagram illustrating, by way of example, a process of determining addresses of a color association table. FIG. 7 shows an a*b* plane in an L*a*b* space.

A defined gamut 110 of the printing machine 18 includes a proximity area 111 near the boundary of the gamut 110, and an encoding area 112 inside of the proximity area 111. As described later, the proximity area 111 tends to have unstable color reproducibility, whereas the encoding area 112 tends to have higher color reproducibility. The readout success rate for the management patches 42 is made higher by using colors in the encoding area 112, rather than using colors in the proximity area 111.

The association table generator 100 sets target color values 114 from among innumerable colors in the encoding area 112 according to prescribed rules. For setting such target color values 114, a variety of setting methods are available, and various types of algorithms can be used. For example, in order for the association table generator 100 to be able to generate color association tables from various gamut configurations according to the same rules, the target color values 114 may be arranged in a grid-like pattern such that color differences between adjacent target color values 114 are substantially equal to each other.

Thereafter, the association table generator 100 assigns different associated numbers to the respective target color values 114, thereby generating a suitable color association table. In FIG. 7, the assigned associated numbers are arranged in a spiral pattern that starts at the origin (L* axis). Values of the associated numbers, and the order of assignment of the associated numbers are not limited to those shown in FIG. 7.

In conjunction with generation of the color association table, an allowable range for errors in color differences between the target color values 114 is established. Such errors in color differences refer to deviations of color reproduction due to performance variations of the colorimeter 20 or the printing machine 18 and due to dry-down. As shown in FIG. 7, closed spaces (color areas) 116 around the respective target color values 114 are established as an allowable range.

Then, a maximum amount of information per print information patch 42b is determined (step S104). Unless color limitations are imposed on the print information patches 42b, the maximum amount of information is equal to the total number of closed spaces 116 to which the associated numbers have been assigned in step S103. The total number of closed spaces 116 is represented by N.

Then, a number of print information patches 42b to be added to the profile color chart 34p is determined (step S105). More specifically, the color ID manager 96 (see FIG. 4) determines the number of print information patches 42b in excess of the total amount of data that makes up the print information. The number of print information patches 42b may be a fixed value, or may be changed depending on the total amount of data that makes up the print information. In this case, the number of print information patches 42b is represented by M.

Thereafter, the print information is encoded (step S106). Print information of the printing machine 18 is encoded by the encoding processor 102 (see FIG. 4) based on the color association table generated in step S3, and then the print information is converted into L*, a*, b* values. Certain specific encoding processes will be described below.

According to the first encoding process, a given ID number is assigned to the associated print information. In other words, combinations of variables (the print mode, the type of the print medium 32, the intended application, the identification number of the printing machine 18, the color sample number of the designated color, etc.) of the print information are uniformly managed by ID numbers.

According to the second encoding process, variables of the print information are correlated in advance with associated numbers of the color association table. For example, the state of a certain ON print mode is correlated with “1”, and the state of an OFF print mode is correlated with “0”. The print information is encoded by a combination of associated numbers, which are correlated with the variables.

According to the third encoding process, variables of the print information are converted into codes, and values of the codes are correlated with associated numbers of the color association table. For example, a registered name “PRINTER-1” of the printing machine 18 is converted into an ASCII code, and the value of the ASCII code is correlated with an associated number of the color association table.

Using any one of the aforementioned encoding processes, it is possible to embed a large amount of print information in one print information patch 42b.

A specific example of the first encoding process will be described below. It is assumed that a given ID number x is a 6-figure numerical value in decimal notation, which is encoded by two colors (L*₁, a*₁, b*₁) and (L*₂, a*₂, b*₂). For example, the color values can be calculated according to the following equations (1) through (6):

L*₁=k×Int{x/(10̂5)}+h (1)

a*₁=k×Int{x/(10̂4)}+h (2)

b*₁=k×Int{x/(10̂3)}+h (3)

L*₂=k×Int{x/(10̂2)}+h (4)

a*₂=k×Int{x/(10̂1)}+h (5)

b*₂=k×Int{x/(10̂0)}+h (6)

Within the range of the given ID numbers, k and h can be determined in advance such that either one of the calculated two colors (L*₁, a*₁, b*₁) and (L*₂, a*₂, b*₂) will fall within the range of the gamut. Assuming the ID numbers can be encoded and decoded, then notation of the ID number x is not limited to decimal notation, but may be selected as desired.

Then, a checksum of the management patches 42 is calculated (step S107). For example, the value of the checksum may be set to a remainder value. Specifically, the value of the checksum may be set to {N−mod(ΣVᵢ, N)}mod(N), where mod represents a modulus operator and {Vᵢ} (i=1, . . . , M) represents a value of each print information patch. In this manner, the color of the checksum patch 42c is determined.

The encoding processor 102 also determines colors of the head patch 42a and the tail patch 42d of the management patches 42. For example, colors that are not used as colors of the color patches 36 or of other management patches 42 may be selected as colors of the head patch 42a and the tail patch 42d, so as to make them easily detectable.

Finally, image data for forming the management patches 42 are generated and added to a portion of the other image data region (step S108). More specifically, the management patch adder 92 replaces a portion of the image data generated by the profile data generator 90 with the image data for forming the management patches 42. The management patches 42 may be placed in a location the can easily be distinguished from the color patches, or at a location that can easily be measured colorimetrically by the operator.

The profile color chart 34p, including the management patches 42 added thereto as print information, is finally printed by the printing machine 18 (step S109). Similarly, the management patches 42 also are added to the designated color adjusting color chart 34c.

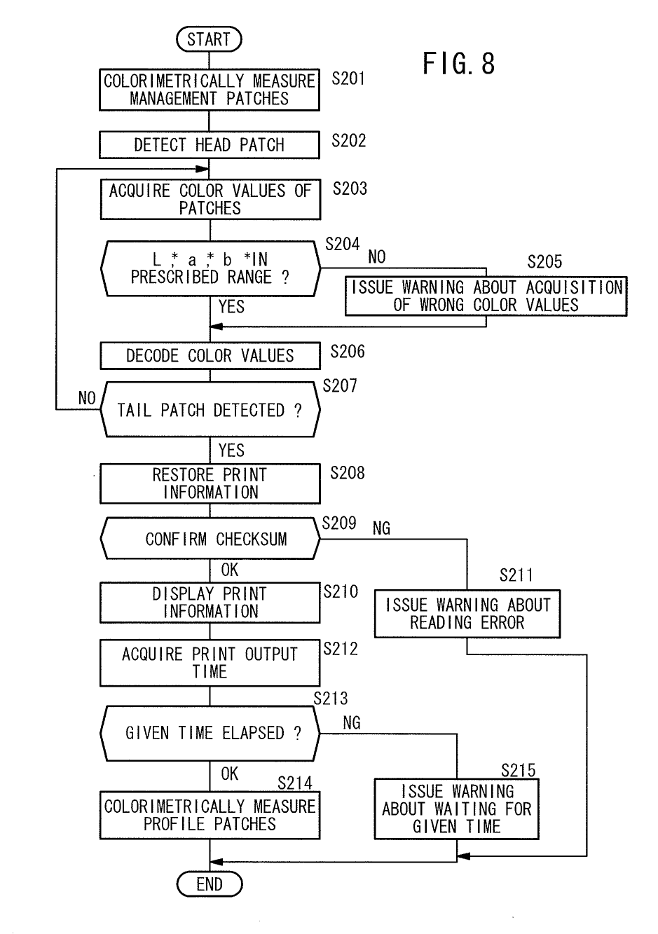

A specific process of acquiring print information from the management patches 42 added to the print 34 will be described below with reference to the flowchart shown in FIG. 8. According to this process, management patches 42 are added to the profile color chart 34p shown in FIG. 2, for example.

First, the management patches 42 are colorimetrically measured (step S201). Specifically, the operator measures colorimetrical values of the management patches 42 successively from the head patch 42a to the tail patch 42d, or from the tail patch 42d to the head patch 42a. Either the head patch 42a or the tail patch 42d may be used as a measurement start position, while the other is used as a measurement end position. The color patches 36 on the profile color chart 34p may be colorimetrically measured in any order.

Then, the head patch 42a is detected (step S202). Specifically, color values of the head patch 42a are detected by the detector 106 from at least one of the acquired color values. If color values, which are not used for any of the color patches 36 or the other management patches 42, are selected as color values for the head patch 42a, then the head patch 42a can more easily be detected.

Then, color values of the other management patches 42 are detected (step S203). In FIG. 2, the operator detects color values of the four print information patches 42b, the checksum patch 42c, and the tail patch 42d, in that order. Then, it is determined whether or not the color values L*, a*, b* fall within a prescribed range (step S204). If the color values L*, a*, b* fall within the prescribed range, then the color values are decoded (step S206). If color values are represented by P1 as shown in FIG. 7, then since the color values fall within the closed space 116 of the target color value 114, to which the associated number “07” is assigned, such color values are decoded into “07”. Since the color values are decoded based on whether they fall within the closed spaces 116 or not, the color values can be decoded while taking into account printing and colorimetric variations.

The color association table is prepared such that the closed spaces 116 do not overlap with each other, and so that the color values can be decoded uniquely even in the presence of printing and colorimetric variations. The closed spaces 116 may be established such that the maximum color difference between two points in one closed space 116 lies within a range of from 5 to 15.

If the encoding area 112 is defined by color values L*, a*, b* where 20≦L*≦80, −30≦a*≦30, and −30≦b*≦30, then the encoding area 112 has a volume of 60×60×60=216000. If one code is assigned to a cube having sides each represented by 6, then the encoding area 112 can produce a maximum of 1000 codes.

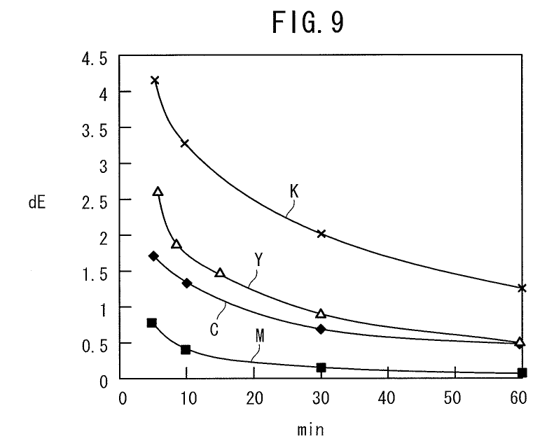

The color association table may be generated depending on density variation characteristics (see FIG. 9) of the print 34 due to dry-down. For example, if the density variations are large, then the intervals between the target color values 114 can be increased, and also, the size of the closed spaces 116 can be increased. In this manner, color values can appropriately be decoded with time-dependent changes in density due to dry-down being taken into account. In other words, the operator does not need to wait until the printed density becomes stabilized after the print 34 has been printed.

The color association table may be generated without using color values in the proximity area 111 near the boundary of the gamut 110 of the printing machine 18. By excluding the proximity area 111 where color reproduction accuracy is lower, and by using color values within the encoding area 112 where color reproduction accuracy is higher, the accuracy (success rate) with which the color values are decoded into print information is further increased.

Moreover, the closed spaces 116 may be reduced in size within a range of color values where color reproducibility of the printing machine 18 is higher, and increased in size within a range of color values where color reproducibility of the printing machine 18 is lower, so that color values can appropriately be decoded while taking into consideration such higher and lower color reproducibility.

The closed spaces 116 are not limited to spherical shapes (see FIG. 7), but may be of a cubic shape, a regular trioctahedral shape, or the like. The closed spaces 116 may be identical in shape to each other in order to simplify the calculating process for determining whether or not the color values exist within the closed spaces 116.

The algorithm for generating the color association table may be changed depending on the gamut, so as to efficiently utilize the encoding area 112 and to assign more numbers thereto.

If the color values L*, a*, b* do not fall within a prescribed range (step S204), then the color manager 70 outputs a warning indicating the acquisition of wrong color values (step S205). The warning may be displayed on the display device 24. The decoding processor 104 selects a target color value 114, which is closest to the acquired color values, and decodes the color values according to the selected target color value 114. More specifically, if as shown in FIG. 7 the color values are represented by P2, then the color values do not fall within any of the closed spaces 116, and the color values are decoded into “06” assigned to a target color value 114 that is closest to P2.

Next, it is determined whether or not the tail patch 42d has been detected (step S207). If the tail patch 42d is not detected, the processes of steps S203 through S207 are repeated. Specifically, the color values of the tail patch 42d are detected from at least one of the acquired color values detected by the detector 106. If color values, which are not used for any of the color patches 36 or the other management patches 42, are selected as color values for the tail patch 42d, then the tail patch 42d can easily be detected.

If the tail patch 42d is detected, then the decoded values are combined to restore the print information of the printing machine 18 (step S208).

Then, a checksum is confirmed (step S209). More specifically, the decision unit 108 (see FIG. 4) divides the sum of the values of the four print information patches 42b and the checksum patch 42c by N to calculate a remainder value. If the remainder value is 0, then the decision unit 108 judges that all the color values have properly been measured (OK). If the remainder value is not 0, then the decision unit 108 judges that at least one of the color values is improper (NG).

If the decision unit 108 judges OK, then the read print information is displayed (step S210). For example, print information of the profile color chart 34p is displayed on the display device 24 in order for the operator to confirm the print information with ease.

If the decision unit 108 judges NG, then a reading error is displayed (step S211). At this time, depending on the confirmed checksum (remainder value), the source or cause of the error, e.g., the colorimeter 20, the printing machine 18, or dry-down, may be determined and displayed on the display device 24.

Then, a time for printing the profile color chart 34p is acquired (step S212). If the read print information includes a time for printing the profile color chart 34p, then the time included therein may be acquired.

Next, the decision unit 108 determines whether or not a given period (first threshold value) has elapsed from printing of the profile color chart 34p (step S213). The first threshold value represents a period that is long enough for any significant time-dependent variations of the color patches 36 due to dry-down to die out. Further details of the first threshold value will be described later.

If the period that has elapsed from the time that the profile color chart 34p was printed exceeds the first threshold value, then the operator measures the color patches 36 of the profile color chart 34p with the colorimeter 20 (step S214). The process of generating a print profile using the acquired color values has already been described above, and will not be described below.

If the period that has elapsed from the time that the profile color chart 34p was printed does not exceed the first threshold value, then the decision unit 108 issues a warning indicating that the decision unit is still waiting for a certain period of time (step S215). In addition to the warning, the decision unit 108 may also display a remaining time until the certain period of time elapses.

In this manner, print information is acquired from the management patches 42, which are added to the profile color chart 34p. Similarly, print information is acquired from the management patches 42, which are added to the designated color adjusting color chart 34c.

The print information acquired from the management patches 42, and the color information obtained by colorimetrically measuring the color chart 34p or 34c (the color patches 36 shown in FIG. 2 or 3) to which management patches 42 have been added, may be correlated with each other and managed. For example, if the management patches 42 are colorimetrically measured in conjunction with the color patches 36 of the profile color chart 34p (see FIG. 2), then it is possible to generate a print profile correlated to the print information of the profile color chart 34p. The print profile can thus be reliably managed without error.

Since the color association table associates print information directly with the color values, print information can be acquired independently of the plotted (recorded) contents of the print 34. Furthermore, since the data converter 98 includes the association table generator 100 for generating a color association table depending on the gamut 110 of the printing machine 18, the color values can appropriately be associated with each other, within a range reproducible by the printing machine 18 and the print information. Even when different types of color charts and prints 34 other than color charts are to be printed, print information of the prints 34 can be acquired without loss of consistency within the same printing machine 18.

Robustness of the printing system 10 as a print information acquiring system can be increased by taking the following items into account:

### 1. Colorimetric Measurement of Management Patches in View of Dry-Down

A process for colorimetrically measuring the management patches 42 in view of dry-down, which is caused after the management patches 42 are printed by the printing machine 18, will be described below.

FIG. 9 is a graph illustrating time-dependent changes in color differences in the print 34, which are caused by dry-down. More specifically, FIG. 9 shows time-dependent changes in color differences between solid images of the respective process colors C, M, Y, K. The graph includes a horizontal axis representing the time (min.) that has elapsed after production of the print 34, and a vertical axis representing the color differences (dE) from color values under a steady dry-down. As shown in FIG. 9, color differences between the colors C, M, Y, K are exponentially changed immediately after the print 34 is produced, until finally the color differences reach a steady state, i.e., a value of 0 on the vertical axis.

Since the color values of the management patches 42 in a steady state can be predicted according to the graph shown in FIG. 9, various processing specifications can be realized as described below.

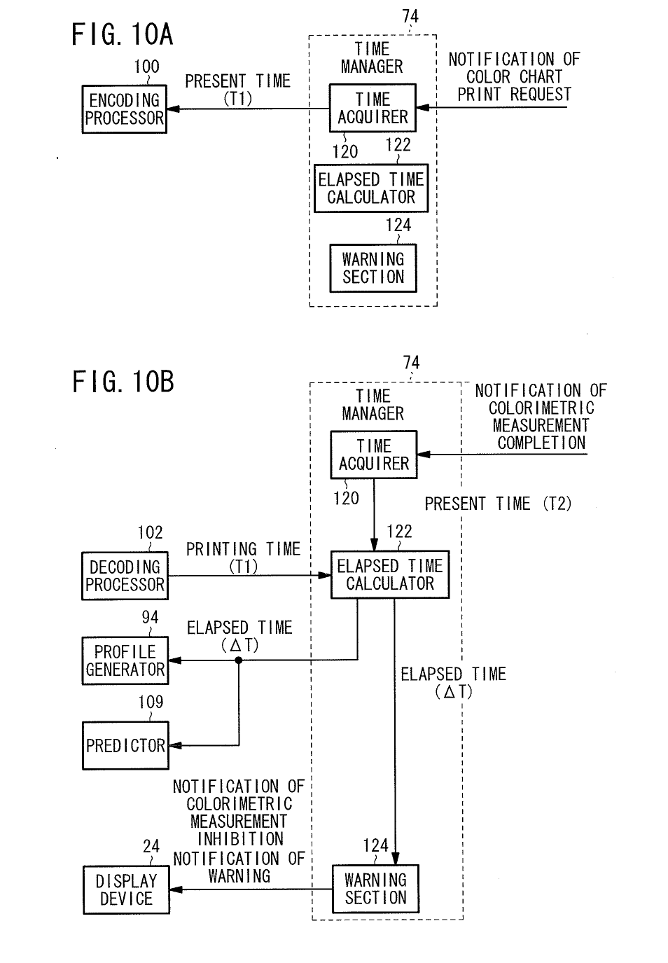

FIGS. 10A and 10B are functional block diagrams showing processing details of the time manager 74 shown in FIG. 4.

FIG. 10A shows the flow of time data upon notification of a color chart printing request. As shown in FIG. 10A, notification of a print request for printing a color chart, e.g., the profile color chart 34p, is sent from a controller, not shown. The notification is received by a time acquirer (colorimetric measurement time acquirer, printing time acquirer) 120, which acquires a present time T=T1. Thereafter, the present time T1 is supplied as the printing time T1, as part of the print information that is sent to the encoding processor 102.

FIG. 10B shows the flow of time data upon notification of completion of a colorimetric measurement performed by the colorimeter 20. As shown in FIG. 10B, notification of completion of the colorimetric measurement is sent from a controller, not shown. This notification is received by the time acquirer 120, which acquires a present time T=T2. Thereafter, the present time T2 is supplied as a colorimetric measurement time T2 to an elapsed period calculator 122.

The printing time T1, which forms part of the print information, is decoded by the decoding processor 104 and supplied to the elapsed period calculator 122. The elapsed period calculator 122 calculates a difference between the present time (colorimetric measurement time) T2 and the printing time T1. The difference represents an elapsed period ΔT after the management patches 42 have been printed by the printing machine 18 and until the management patches 42 are measured colorimetrically.

The elapsed period ΔT is supplied to a warning section 124, which compares the elapsed period ΔT with preset threshold values, including a first threshold value and a second threshold value. If the elapsed period ΔT is equal to or smaller than the first threshold value, then a display controller, not shown, displays a warning image on the display device 24. If the elapsed period ΔT is equal to or smaller than the second threshold value (the second threshold value is smaller than the first threshold value), then the display controller displays on the display device 24 a message indicating inhibition of data acquisition from the colorimeter 20. At this time, the color manager 70 does not use the measured results, i.e., the color values of the color patches 36, or the management patches 42 acquired during the elapsed period ΔT.

The elapsed period ΔT is supplied to the profile generator 94 and used to predict color values L*, a*, in a steady state of the profile color chart 34p.

Specifically, even when colors of the color patches 36 are changed due to dry-down after the profile color chart 34p has been printed, the profile generator 94 can estimate and generate a print profile after elapse of a sufficient period of time following printing of the profile color chart 34p, using the color values L*, a*, b* acquired by the colorimeter 20 and the supplied elapsed period ΔT. Since the colorimeter 20 can measure color values without requiring any waiting time, operation efficiency is increased.

Similarly, the elapsed period ΔT, which is calculated by the elapsed period calculator 122, is supplied to the predictor 109 and is used to predict color values L*, a*, in a steady state of the management patches 42. Reading accuracy at which the management patches 42 are read can thus be increased.

For calculating the elapsed period ΔT more strictly, a time at which the image data of the color charts are transferred from the image processing apparatus 16 to the printing machine 18 may be defined as the printing time T1. In this case, since the transfer time cannot directly be incorporated into the management patches 42, the transfer time may be stored separately in the storage unit 82 of the image processing apparatus 16, and may be read therefrom when necessary.

A time acquisition patch may be provided, which serves as a trigger for acquiring the colorimetric measurement time T2 from the management patches 42. For example, the head patch 42a or the tail patch 42d may function as such a time acquisition patch. Alternatively, such a time acquisition patch may be provided in addition to the management patches 42 shown in FIGS. 2 and 3.

A third threshold value for determining whether or not the density of the management patches 42 is capable of being measured may be provided. The third threshold value may be identical to or different from the first or the second threshold value for determining the density of color patches 36 of the profile color chart 34p or the density of color patches 36 of the designated color adjusting color chart 34c.

Since the printing time T1 is acquired for the management patches 42, the management patches 42 are colorimetrically measured, the colorimetric measurement time T2 for the management patches 42 is acquired, and the elapsed period ΔT after the management patches 42 are printed and until they are colorimetrically measured is calculated based on the acquired printing time T1 and the acquired colorimetric measurement time T2, the elapsed period ΔT can automatically be acquired. Consequently, even if the management patches 42 are colorimetrically measured while the density thereof is changed due to dry-down, the print information represented by the color values of the management patches 42 can properly be recognized, and hence can appropriately be acquired.

### 2. ID Management for a Plurality of Printing Machines

Actually, the printing system 10 can have a plurality of printing machines 18, which are connected respectively to one image processing apparatus 16. Insofar as print information has to be managed for each of the printing machines 18, in principle, the amount of data to be managed by the printing system 10 overall is enormous. If a plurality of printing machines 18 of one type are connected to the image processing apparatus 16, then the same print information is managed individually for each of such printing machines, and in reality, the management of such print information is quite redundant.

Therefore, it is preferable to manage the print information uniformly based on ID numbers, which are defined commonly for a plurality of printing machines 18.

Specifically, ID numbers defined commonly for a plurality of printing machines 18 are established. A first association table, which associates given color values (colors in an overlapping area of gamuts) with the ID numbers, is generated. Also, a second association table, which associates the ID numbers with the print information for each of the printing machines 18, is generated, thereby associating the colors of the management patches 42 with the print information.

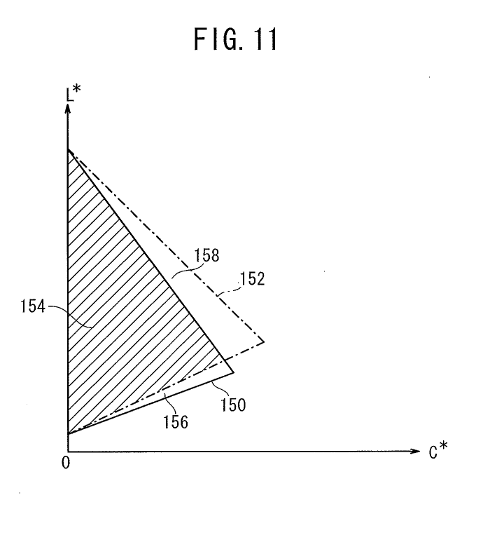

FIG. 11 is a graph showing a positional relationship between gamuts of two printing machines 18. For illustrative purposes, the two printing machines 18 will hereinafter be referred to as a first printing machine 18a and a second printing machine 18b.

The graph shown in FIG. 11 represents an H*-axis cross-sectional view of an L*C*H* space, having a horizontal axis representing a C*-axis, and a vertical axis representing an L*-axis. An area surrounded by the solid lines represents a gamut 150 of the first printing machine 18a, and an area surrounded by the dot-and-dash lines represents a gamut 152 of the second printing machine 18b.

The gamut 150 and the gamut 152 have an overlapping area 154. Since both the first printing machine 18a and the second printing machine 18b can reproduce colors in the overlapping area 154, common ID numbers (global ID numbers) can be used for the overlapping area 154. A differential, which is set between the gamut 150 and the overlapping area 154, is referred to as a non-overlapping area 156. Since only the first printing machine 18a can reproduce colors in the non-overlapping area 156, ID numbers (private ID numbers) unique to the first printing machine 18a are used for the non-overlapping area 156. A differential, which is set between the gamut 152 and the overlapping area 154, is referred to as a non-overlapping area 158. Since only the second printing machine 18b can reproduce colors in the non-overlapping area 158, ID numbers (private ID numbers) unique to the second printing machine 18b are used for the non-overlapping area 158.

Global ID numbers are assigned to colors in the overlapping area 154, and private ID numbers are assigned to colors in the non-overlapping areas 156 and 158. Consequently, one private ID number can be assigned to one color in the non-overlapping area 156, and to one color in the non-overlapping area 158. In other words, different printing conditions can be assigned respectively to the printing machines 18.

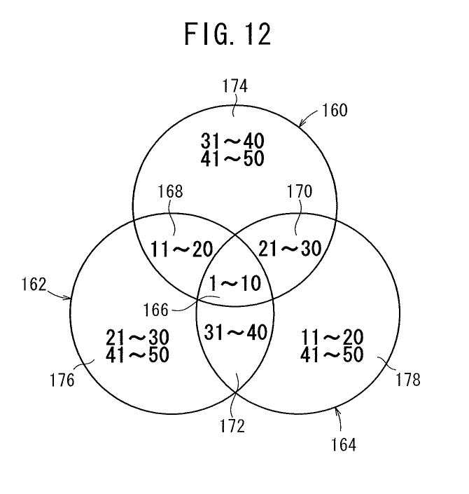

FIG. 12 is a diagram illustrating a process of setting ID numbers for three printing machines 18. For illustrative purposes, the three printing machines 18 will hereinafter be referred to as a first printing machine 18a, a second printing machine 18b, and a third printing machine 18c.

In FIG. 12, substantially circular gamuts 160, 162, 164, which are indicated by solid lines, belong to the first printing machine 18a, the second printing machine 18b, and the third printing machine 18c, respectively.

The gamuts 160, 162, 164 have an overlapping area 166. Since all of the three printing machines, i.e., the first printing machine 18a, the second printing machine 18b, and the third printing machine 18c, can reproduce colors in the overlapping area 166, common ID numbers (global ID numbers) can be used for the overlapping area 166. In FIG. 12, ID numbers 1 through 10 are assigned to the overlapping area 166.

The gamuts 160, 162 have a partial overlapping area 168. Since the first printing machine 18a and the second printing machine 18b can reproduce colors in the partial overlapping area 168, ID numbers (private ID numbers) common to the first printing machine 18a and the second printing machine 18b are used for the partial overlapping area 168. In FIG. 12, ID numbers 11 through 20 are assigned to the partial overlapping area 168.

The gamuts 160, 164 have a partial overlapping area 170. Since the first printing machine 18a and the third printing machine 18c can reproduce colors in the partial overlapping area 170, ID numbers (private ID numbers) common to the first printing machine 18a and the third printing machine 18c are used for the partial overlapping area 170. In FIG. 12, ID numbers 21 through 30 are assigned to the partial overlapping area 170.

The gamuts 162, 164 have a partial overlapping area 172. Since the second printing machine 18b and the third printing machine 18c can reproduce colors in the partial overlapping area 172, ID numbers (private ID numbers) common to the second printing machine 18b and the third printing machine 18c are used for the partial overlapping area 172. In FIG. 12, ID numbers 31 through 40 are assigned to the partial overlapping area 172.

A differential, which is set between the gamut 160, the overlapping area 166 and the partial overlapping areas 168, 170, is referred to as a non-overlapping area 174. Since only the first printing machine 18a can reproduce colors in the non-overlapping area 174, ID numbers (private ID numbers) unique to the first printing machine 18a are used for the non-overlapping area 174. In FIG. 12, ID numbers 31 through 50, which have not been assigned to the first printing machine 18a, are assigned to the non-overlapping area 174.

A differential, which is set between the gamut 162, the overlapping area 166 and the partial overlapping areas 168, 172, is referred to as a non-overlapping area 176. Since only the second printing machine 18b can reproduce colors in the non-overlapping area 176, ID numbers (private ID numbers) unique to the second printing machine 18b are used for the non-overlapping area 176. In FIG. 12, ID numbers 21 through 30 and 41 through 50, which have not been assigned to the second printing machine 18b, are assigned to the non-overlapping area 176.

A differential, which is set between the gamut 164, the overlapping area 166 and the partial overlapping areas 170, 172, is referred to as a non-overlapping area 178. Since only the third printing machine 18c can reproduce colors in the non-overlapping area 178, ID numbers (private ID numbers) unique to the third printing machine 18c are used for the non-overlapping area 178. In FIG. 12, ID numbers 11 through 20 and 41 through 50, which have not been assigned to the third printing machine 18c, are assigned to the non-overlapping area 178.

According to the process illustrated in FIG. 12, it is possible to uniformly manage common ID numbers, and thus the amount of data involved can be reduced. Other management of data, such as registration and deletion of data, can also be facilitated.

Specifically, as shown in FIG. 12, if 50 items of print information are managed for each of the three printing machines, it has heretofore been necessary to manage a total of 150 colors for the three printing machines.

According to the present embodiment, however, it is only necessary to manage a total of 100 colors for the three printing machines.

If the printing system 10 includes a plurality of image processing apparatus 16, then respective management apparatus therefor may be provided separately, depending on the types of ID numbers used. For example, global ID numbers may be managed uniformly by the database DB connected to the LAN 12 (see FIG. 1). Private ID numbers assigned to the respective printing machines 18 may be managed individually by the respective image processing apparatus 16 (the color ID manager 96 shown in FIG. 4), which are connected to the printing machines 18.

### 3. Prediction of Color Values of a Print After the Print is Covered With a Protective Film

If a protective film, such as a laminating film, is applied to the image forming surface of the print 34, then the color values of a color image on the print 34 may be changed in a non-negligible manner before and after the laminating film is applied. A print with a protective film applied thereto will be referred to as a “protective-film-applied print”.

Usually, the color patches 36 of the profile color chart 34p, which is free of a protective film, are colorimetrically measured in view of better operation efficiency and economy. However, it may be necessary to measure the management patches 42 in order to reconfirm the print information after the designated color adjusting color chart 34c has been covered with a protective film and the designated color is adjusted in color. In such a case, inasmuch as different color values are produced before and after the laminating film is applied, it is possible that the print information encoded by the management patches 42 will not be acquired properly. However, once the protective film is applied, it is virtually impossible, or highly difficult, to peel the applied protective film off from the print 34.

To solve this problem, the acquired color values of the management patches 42 may be corrected depending on whether a protective film is present or not, and also depending on the type of protective film, and then the acquired color values are decoded into print information. In this manner, the color values of the management patches 42 can properly be decoded irrespective of whether the management patches 42 are colorimetrically measured before or after the print 34 has been covered with a protective film.

Alternatively, the color values that are encoded from the print information may be corrected in advance depending on whether or not the protective film is present, and also depending on the type of protective film utilized when the management patches 42 are colorimetrically measured. In this manner, color values of the management patches 42 can properly be decoded, irrespective of whether the management patches 42 are colorimetrically measured before or after the print 34 has been covered with the protective film.

### 4. Process of Printing Management Patches

If the printing machine 18 is an ink jet printer, then as the amount of inks applied to the print medium 32 becomes greater, it takes longer for the applied inks in the print medium 32 and on the surface of the print medium 32 to dry sufficiently. In addition, if the applied inks exceed an allowable amount that can be absorbed by the print medium 32 or an allowable rate at which the applied inks can be absorbed by the print medium 32, then the surface of the print medium 32 may possibly cause overflowing of the inks. If the management patches 42 are colorimetrically measured before elapse of a sufficient drying period after images have been formed on the print medium 32, then the following drawbacks tend to occur:

If the colorimeter 20 or the operator mistakenly touches the print medium 32 exhibiting ink overflow at a certain location thereon, then since the inks become applied to the colorimeter 20 or the operator, the location on the print 34 is liable to become discolored or to exhibit mixed coloration. In addition, since the abrasion resistance of the surface of the print medium 32 is reduced when the applied inks are not dried sufficiently, the surface of the print 34 may develop scratch marks therein. In either case, the print 34 tends to be subjected to a printing failure, and may lead to malfunctioning of the colorimeter 20.

To avoid the above difficulties, color values of the management patches 42 may be selected depending on the ink amounts used to print the management patches 42. Accordingly, the ink amounts to be used can be recognized in advance, and variations in the printed density due to dry-down can be estimated.

Color values of the management patches 42 may be selected such that the total amount of color inks used to print the management patches 42 will be smaller than the total amount of color inks used to print a print area (images, characters, etc.) of the print medium 32 other than the management patches 42. The surface of the print medium 32 where the management patches 42 are printed is thus prevented from suffering from ink overflow, so that the time required for the inks to dry can be shortened. Moreover, variations in the printed density due to dry-down can also be reduced.

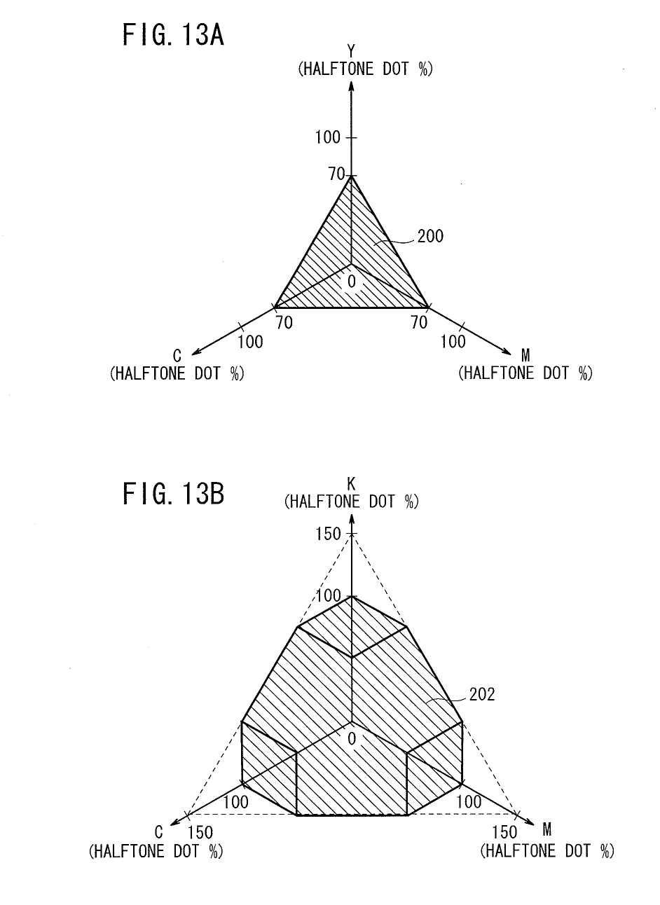

FIGS. 13A and 13B are conceptual diagrams showing examples of determining ink amounts used to print management patches. In FIGS. 13A and 13B, three ink colors C, M, Y (or C, M, K) are shown for illustrative purposes. However, the number of ink colors and the combinations thereof can be changed as desired.

FIG. 13A shows an example of determining the amounts of C, M, Y inks, which are water-based inks that are soluble by a solvent mainly composed of water. In FIG. 13A, each of a C-axis, an M-axis, and a Y-axis represents a halftone dot percentage (corresponding to a range from 0% to 100% in terms of the ejected amount of ink), which is set in a range from 0% to 100%. In FIG. 13A, a region 200 is provided in the shape of a triangular pyramid having a plane defined by three points (C, M, Y)=(70, 0, 0), (0, 70, 0), (0, 0, 70) and a vertex at the origin O. The total amount of C, M, Y inks can be 70% or smaller at all times, using any desired colors within the region 200.

FIG. 13B shows an example of determining the amounts of C, M, Y inks, which are pigment-based inks that a soluble by a solvent mainly composed of an organic solvent. In FIG. 13B, each of a C-axis, an M-axis, and a Y-axis represents a halftone dot percentage (corresponding to a range from 0% to 100% in terms of the ejected amount of ink), which is set in a range from 0% to 100%. In FIG. 13B, there is provided a region 202 in the shape of a heptahedron defined by removing three small triangular pyramids having respective vertexes at (C, M, Y)=(150, 0, 0), (0, 150, 0), (0, 0, 150) from a larger triangular pyramid shown by the broken lines. The total amount of C, M, Y inks can be 150% or smaller at all times, using any desired colors within the region 202.

The printing machine driver 66 (see FIG. 4) converts C, M, Y, K data corresponding to color values of the management patches 42 into appropriate ink propulsion control data. A color conversion LUT of the printing machine driver 66 may be referred to, and only color values that reduce the amount of inks used when the printing machine 18 produces prints may be selected in advance.

The above process of printing the management patches 42 also is applicable when standard inks of colors C, M, Y, K (process colors), optional inks of light colors such as LC, LM, etc., and achromatic colors such as white and clear are used. For minimizing the amount of inks to be used as well as widening the color reproduction range within the gamut 110, for example, light color inks and achromatic color inks may not be used, whereas inks of dark colors such as process colors mainly may be used.

If the printing machine 18 is capable of controlling the ejected ink amounts so as to form ink dots on the print medium 32 in a plurality of ink dot sizes or diameters, then the ejected ink amounts may be selected in order to widen the color reproduction range. For example, an image may be formed in which the ink dot diameters are increased in order to increase the color reproduction range of L* (especially shadows).

Furthermore, for making the density at which the color inks are applied to the print medium 32 uniform, the printing machine driver 66 may generate ink propulsion control data in order to allocate ink droplets (amounts), which are microscopically equal to the print medium 32.

A printing period for the print 34 may be estimated based on a print mode in a print area other than the management patches 42, and the ink amounts used to form the management patches 42 may be determined in view of the estimated printing period.

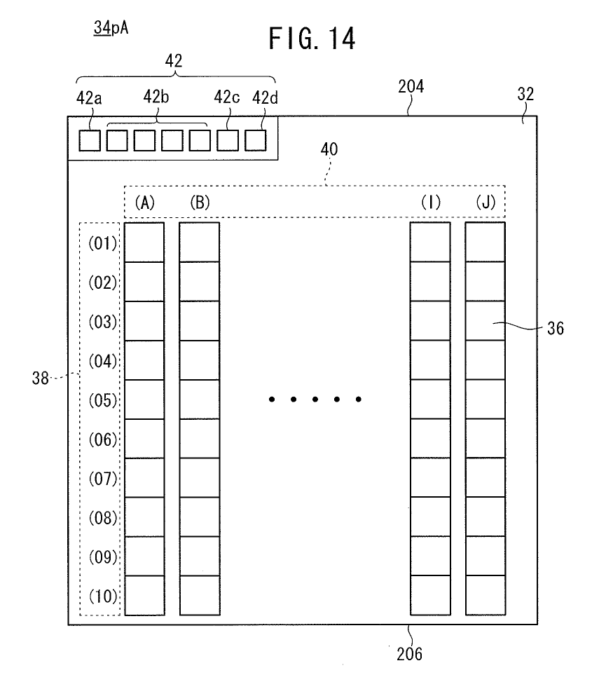

FIG. 14 shows a profile color chart 34pA, which is a modification of the profile color chart 34p shown in FIG. 2. The profile color chart 34pA includes management patches 42 on a leading end 204 of the print medium 32, i.e., at an upstream end of the print medium 32 with respect to the direction in which the print medium 32 is fed.

The print 34, i.e., the print medium 32, is held in the printing machine 18 after the printing machine 18 starts to print the print 34 and until the print 34 is printed completely down to a trailing end 206 thereof, i.e., until the print area (the color patches 36 in FIG. 14) is printed in its entirety. When the print medium 32 is cut off and the print 34 is discharged from the printing machine 18, a considerable period of time has elapsed since printing of the management patches 42. As can be seen from the density variation characteristics (see FIG. 9) of the print 34, due to dry-down, variations in the printed density of the management patches 42 are reduced by the time the management patches 42 can be colorimetrically measured.

With the management patches 42 positioned on the leading end 204 of the print medium 32, i.e., the end of the print medium 32 that initially is printed, the period of time (elapsed time ΔT) from the printing time T1 to the colorimetric measurement time T2 is increased. As a result, the process of decoding the management patches 42 is increased in accuracy, despite variations in the printed density due to dry-down.

The present invention is not limited to the above embodiment. Various changes and modifications can be made without departing from the scope of the invention, as described below.

In the illustrated embodiment, the profile color chart 34p (see FIG. 2) has 100 color patches 36, while the designated color adjusting color chart 34c (see FIG. 3) has 49 color patches. However, the profile color chart 34p and the designated color adjusting color chart 34c may have different numbers of color patches.

In the illustrated embodiment, the profile color chart 34p and the designated color adjusting color chart 34c are illustrated by way of example. However, other types of color charts may be printed. For example, a color chart may be printed, which can be presented to a client for final confirmation of a designated color.

In the illustrated embodiment, a single image processing apparatus 16 operates to perform various functions to (1) encode print information, (2) instruct the printing machine 18 to produce a print, (3) acquire colorimetric data, (4) decode management patches, and (5) acquire print information. However, a plurality of respective apparatus may be used to perform the above functions. For example, the color association table of the printing machine 18 may uniformly be managed by the database DB. In such a case, color values of the management patches 42, which are acquired by the colorimeter 20, are sent from the image processing apparatus 16 to the database DB, which converts the color values into print information of the print 34. In this manner, the image processing apparatus 16 can acquire print information of the print 34 without the need for the decoding processor 104.

In the illustrated embodiment, the printing machine 18 comprises an ink jet printer. However, the printing machine 18 may comprise an offset printing press, an electrophotographic printer, a thermosensitive printer, or the like.

Although certain preferred embodiments of the present invention have been shown and described in detail, it should be understood that various changes and modifications may be made to the embodiments without departing from the scope of the invention as set forth in the appended claims.

What is claimed is:

1. A print information acquiring method comprising the steps of:
generating an association table associating print information with color values;
encoding print information of a print into prescribed color values based on the generated association table;
adding image data of management patches having the prescribed color values to image data for printing the print;
acquiring color values of the management patches added to the print that is printed by a printing machine; and
decoding the acquired color values of the management patches into the print information based on the association table,
wherein in the step of generating the association table, the association table is generated depending on a gamut of the printing machine.

2. A print information acquiring method according to claim 1, wherein in the step of decoding the acquired color values, the color values of the management patches are decoded into the print information based on whether the color values belong to color areas around the prescribed color values.

3. A print information acquiring method according to claim 2, wherein in the step of generating an association table, the association table is generated such that the color areas do not overlap each other.

4. A print information acquiring method according to claim 1, wherein in the step of generating the association table, the association table is generated without using color values in a proximity area near a boundary of the gamut of the printing machine.

5. A print information acquiring method according to claim 1, wherein in the step of generating the association table, the association table is generated depending on density variation characteristics of the print caused by dry-down.

6. A print information acquiring method according to claim 2, wherein in the step of decoding the acquired color values, the color areas are reduced in size within a range of color values where color reproducibility of the printing machine is higher, and are increased in size within a range of color values where color reproducibility of the printing machine is lower.

7. A print information acquiring method according to claim 1, wherein in the step of encoding print information, the prescribed color values are corrected depending on whether or not a surface of the printed management patches is covered with a protective film.

8. A print information acquiring method according to claim 1, wherein in the step of decoding the acquired color values, the color values of the management patches are corrected depending on whether or not a surface of the printed management patches is covered with a protective film, and then decoded into the print information.

9. A print information acquiring method according to claim 1, further comprising the steps of:
acquiring a printing time for printing the management patches;
acquiring a colorimetric measurement time for colorimetrically measuring the management patches; and
calculating an elapsed period after the management patches are printed and until the management patches are colorimetrically measured, based on the acquired printing time and the acquired colorimetric measurement time.

10. A print information acquiring method according to claim 9, wherein the management patches include a colorimetry success/failure detecting patch, the method further comprising the step of:
determining whether or not the color values of the management patches are successfully acquired based on acquired color values of the colorimetry success/failure detecting patch.

11. A print information acquiring method according to claim 9, further comprising the step of:
issuing a warning if the calculated elapsed period is equal to or smaller than a first threshold value.

12. A print information acquiring method according to claim 9, further comprising the step of:
inhibiting the color values from being acquired within a prescribed time range if the calculated elapsed period is equal to or smaller than a second threshold value.

13. A print information acquiring method according to claim 9, further comprising the step of:
predicting the color values of the management patches in a steady state of dry-down, based on the acquired color values of the management patches and the calculated elapsed period.

14. A print information acquiring method according to claim 9, wherein the management patches include a time acquisition patch, the method further comprising the step of:
in the step of acquiring the colorimetric measurement time, acquiring a time for colorimetrically measuring the time acquisition patch as the colorimetric measurement time for colorimetrically measuring the management patches.

15. A print information acquiring method according to claim 9, wherein the print information includes the printing time.

16. A print information acquiring method according to claim 9, wherein the print includes a color chart having a plurality of color patches.

17. A print information acquiring method according to claim 1, wherein the print is printed by an ink-jet printing machine, and the prescribed color values are selected depending on amounts of inks used to print the print.

18. A print information acquiring method according to claim 17, wherein the prescribed color values are selected such that a total amount of inks of colors used to print the management patches is smaller than a total amount of inks of colors used to print a print area of the print other than the management patches.

19. A print information acquiring apparatus comprising:
an association table generator for generating an association table associating print information with color values;
an encoding processor for encoding print information of a print into prescribed color values based on the association table generated by the association table generator;
a patch adder for adding image data of management patches having the prescribed color values to image data for printing the print;
a colorimetric unit for acquiring color values of the management patches added by the patch adder to the print that is printed by a printing machine; and
a decoding processor for decoding the color values of the management patches acquired by the colorimetric unit into the print information based on the association table,
wherein the association table is generated depending on a gamut of the printing machine.

20. A print information acquiring apparatus according to claim 19, further comprising:
a printing time acquirer for acquiring a printing time for printing the management patches;
a colorimetric measurement time acquirer for acquiring a colorimetric measurement time for colorimetrically measuring the management patches; and
an elapsed period calculator for calculating an elapsed period after the management patches are printed and until the management patches are colorimetrically measured, based on the printing time acquired by the printing time acquirer and the colorimetric measurement time acquired by the colorimetric measurement time acquirer.

21. A profile generating method comprising the steps of:
generating an association table associating print information with color values;
encoding print information of a color chart having a plurality of color patches into prescribed color values based on the generated association table;
adding image data of management patches having the prescribed color values to image data for printing the color chart;
acquiring color values of the color patches and color values of the management patches added to the color chart that is printed by a printing machine;
decoding the acquired color values of the management patches into the print information based on the association table; and
generating a profile based on the acquired color values of the color patches and the decoded print information.

22. A profile generating method according to claim 21, wherein the print information includes a printing time for printing the management patches, the method further comprising the steps of:
acquiring a colorimetric measurement time for colorimetrically measuring the management patches;
calculating an elapsed period after the management patches are printed and until the management patches are colorimetrically measured based on the decoded printing time and the acquired colorimetric measurement time; and
determining whether the calculated elapsed period exceeds a predetermined value or not,
wherein the profile is generated in the step of generating the profile only if the calculated elapsed period is judged in the determining step as exceeding the predetermined value.

23. A computer-readable recording medium storing therein a program for enabling a computer to perform the functions of:
generating an association table associating print information with color values, depending on a gamut of a printing machine for printing a print;
encoding print information of the print into prescribed color values based on the generated association table;
adding image data of management patches having the prescribed color values to image data for printing the print;
acquiring color values of the management patches added to the print that is printed by the printing machine; and
decoding the color values of the acquired management patches into the print information based on the association table.

24. A computer-readable recording medium according to claim 23, wherein the program further enables the computer to perform the functions of:
acquiring a printing time for printing the management patches;
acquiring a colorimetric measurement time for colorimetrically measuring the management patches; and
calculating an elapsed period after the management patches are printed and until the management patches are colorimetrically measured based on the acquired printing time and the acquired colorimetric measurement time.
